(19) United States
(12) Patent Application Publication
(10) Pub. No.: US 2026/0073000 A1
(43) Pub. Date: Mar. 12, 2026

(54) Intelligent URL Handling for LLM Response Generation in OCI RAG Agent Services

(71) Applicant: Oracle International Corporation, Redwood Shores, CA (US)

(72) Inventors: Mengqing Guo, Redmond, WA (US); Rongguang Wang, Seattle, WA (US); Zheng Wang, Sammamish, WA (US); Xin Zhang, Seattle, WA (US); Yazhe Hu, Bellevue, WA (US); Zhonghai Deng, Redmond, WA (US); Yimo Liu, Seattle, WA (US); Yuying Wang, Lexington, KY (US); Genyi Huang, Boston, MA (US); Tao Sheng, Bellevue, WA (US)

(73) Assignee: Oracle International Corporation, Redwood Shores, CA (US)

(21) Appl. No.: 18/929,491

(22) Filed: Oct. 28, 2024

Related U.S. Application Data
(60) Provisional application No. 63/692,059, filed on Sep. 7, 2024.

(51) Int. Cl. G06F 16/955; G06F 9/451

(52) U.S. Cl. CPC G06F 16/9566; G06F 9/451; G06F 16/9558

(57) ABSTRACT

Techniques for URL handling in Retrieval-Augmented Generation (RAG) systems are disclosed. A RAG system uses a generative AI response in the selection of links to include in a modified output from a RAG system. The links are based on URLs that are extracted from ingested documents. In response to a query, the system generates a response and then performs a matching operation to match a portion of the generated response to a URL in a URL-keyword mapping. The system finds a match between a portion of the generated response and a keyword that is associated with a URL, generates a hyperlink using the matched URL, and adds the hyperlink to the response.

### BENEFIT CLAIMS; RELATED APPLICATIONS; INCORPORATION BY REFERENCE

This application claims the benefit of U.S. Provisional Patent Application 63/692,059, filed Sep. 7, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning systems. In particular, the present disclosure relates to retrieval augmented generation system evaluation.

### BACKGROUND

Retrieval-Augmented Generation (RAG) agents are used in applications requiring dynamic access to external information during the response generation process. Traditional machine learning models, particularly large language models (LLMs), rely on static training data and may lack the ability to provide responses based on information that becomes available after the training phase. In contrast, RAG agents address this limitation by retrieving up-to-date information from external sources, making them particularly useful in fields where information is constantly evolving or too vast to be incorporated into a model's static knowledge. This makes RAG agents well-suited for applications, such as customer service chatbots, real-time data analysis, medical research, and personalized recommendation systems, where they retrieve and integrate relevant data on-demand, offering more precise and contextually relevant outputs.

RAG agents are commonly deployed in various sectors, such as healthcare, finance, and e-commerce, due to their ability to process and synthesize information from large databases in real-time. In healthcare, for instance, RAG agents can quickly access vast repositories of medical literature and patient data to support medical diagnoses or provide personalized treatment recommendations. This contrasts with more basic machine learning models that would be limited to the information they were trained on and unable to consider new research or patient-specific factors after the training period. In e-commerce, RAG agents enable personalized shopping experiences by analyzing current user behavior and historical data to suggest products, ensuring that recommendations remain relevant and timely. This retrieval-based approach significantly enhances the model's utility in domains where accuracy and up-to-date knowledge are desirable.

One of the distinctions between RAG agents and traditional machine learning models lies in their handling of data. Standard models operate within the confines of their training set and may struggle with novel queries that fall outside of their trained knowledge. In contrast, RAG agents are designed to overcome this limitation by retrieving data from external sources in real-time, making them highly adaptable to a wide range of queries. This retrieval mechanism allows RAG agents to augment their responses with fresh, domain-specific knowledge that would otherwise be unavailable to traditional models. As a result, RAG agents are capable of addressing a broader spectrum of questions with higher accuracy, particularly in domains where information evolves rapidly or is too extensive to be fully encapsulated within a training dataset.

The integration of agents into the RAG framework introduces enhanced flexibility and scalability compared to traditional machine learning models. While conventional models are often static and should be retrained to incorporate new data, RAG agents operate in a more dynamic fashion, augmenting their knowledge base through external retrieval mechanisms. This allows RAG agents to remain relevant in real-time environments, where the need for current information is desirable. Traditional models, by contrast, require frequent updates and retraining to maintain accuracy, a process that can be both time-consuming and computationally expensive. RAG agents provide a more efficient and scalable solution, as they leverage external data without needing to undergo constant retraining, making them ideal for applications requiring both precision and adaptability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a machine learning engine in accordance with one or more embodiments;

FIG. 2 illustrates the operation of a machine learning engine in one or more embodiments;

FIG. 3 illustrates a system in accordance with one or more embodiments;

FIG. 4 illustrates an example set of operations for URL handing in RAG systems in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. GENERATIVE MODELS
4. RAG SYSTEM URL HANDLING ARCHITECTURE
5. URL HANDLING A RAG SYSTEM
6. COMPUTER NETWORKS AND CLOUD NETWORKS
7. HARDWARE OVERVIEW
8. MISCELLANEOUS; EXTENSIONS

### 1. General Overview

One or more embodiments use a generative AI response in the selection of links to include in a modified output from a RAG system. The links are based on URLs that are extracted from ingested documents. URLs often serve as valuable sources of up-to-date and specific information. Effectively handling and integrating information from URLs into the generative process can significantly enhance the quality and relevance of responses. One or more embodiments implement a system for effective URL handling that accurately retrieves, processes, and integrates information from URLs into the generative process.

An embodiment generates a response to a query. The system then performs a matching operation to match a portion of the generated response to one or more URLs in a URL dictionary that includes a URL-keyword mapping. The system finds a match between a portion of the generated response and a keyword that is associated with a URL, and uses this information to update the generated response. The process of updating the generated response includes generating a hyperlink using the matched URL, and adding the hyperlink to the response. The result is a generated response that includes a URL that was extracted from one of the documents ingested by the RAG system. By using URLs that are extracted from ingested documents rather than generating URLs with a LLM, the RAG system reduces opportunity for hallucination of URLs. Once the generated response is updated with the URL, the updated generated response is presented as a response to the query.

One or more embodiments described in this Specification and/or recited in the claims may not be included in this General Overview section.

### 2. Machine Learning Architecture

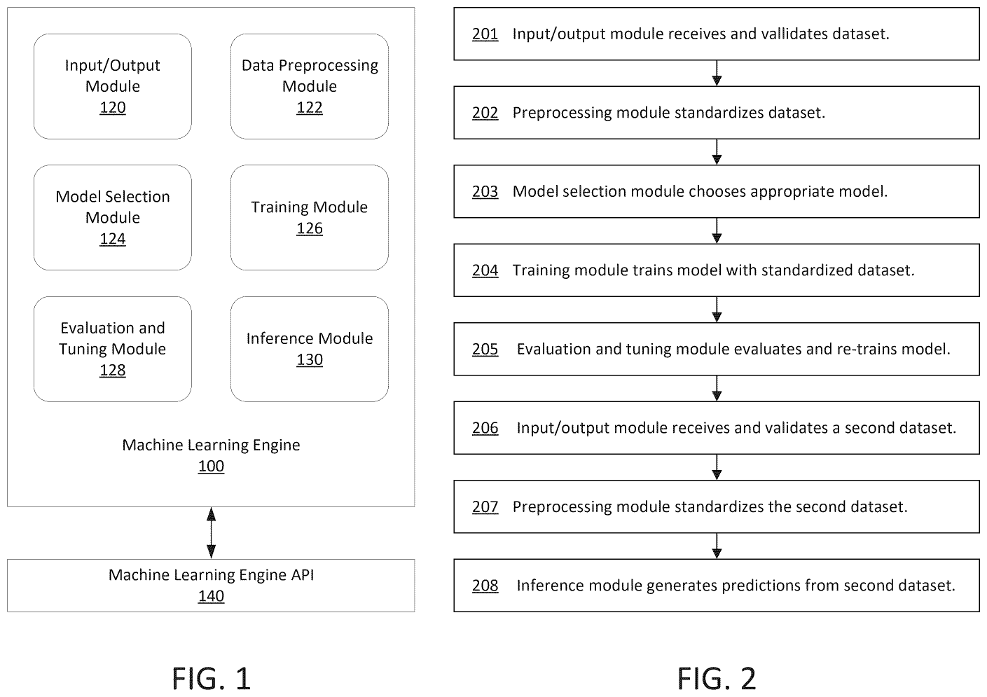

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly.

Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters - settings that govern the model's learning process but are not directly learned from the data - to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert.

Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. In an embodiment, input/output module 120 receives a dataset intended for training (Operation 201). This data can originate from diverse sources, like databases or real-time data streams, and in varied formats, such as CSV, JSON, or XML. Input/output module 120 assesses and validates the data, ensuring its integrity by checking for consistency, data ranges, and types.

In an embodiment, training data is passed to data preprocessing module 122. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 122 is then fed into model selection module 124 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 126 trains the selected model with the prepared dataset (Operation 204). It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

In an embodiment, evaluation and tuning module 128 evaluates the trained model's performance using the validation dataset (Operation 205). Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 120 receives a dataset intended for inference. Input/output module 120 assesses and validates the data (Operation 206).

In an embodiment, data preprocessing module 122 receives the validated dataset intended for inference (Operation 207). Data preprocessing module 122 ensures that the data format used in training is replicated for the new inference data, maintaining consistency and accuracy for the model's predictions.

In an embodiment, inference module 130 processes the new data set intended for inference, using the trained and tuned model (Operation 208). It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as /ubmitData facilitate the submission of new data for processing, while/etrieveResults is designed for fetching the outcomes of data analysis or model predictions. The MLE API may also include endpoints like/pdateModel for model modifications and/rainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 4. Rag System Url Handling Architecture

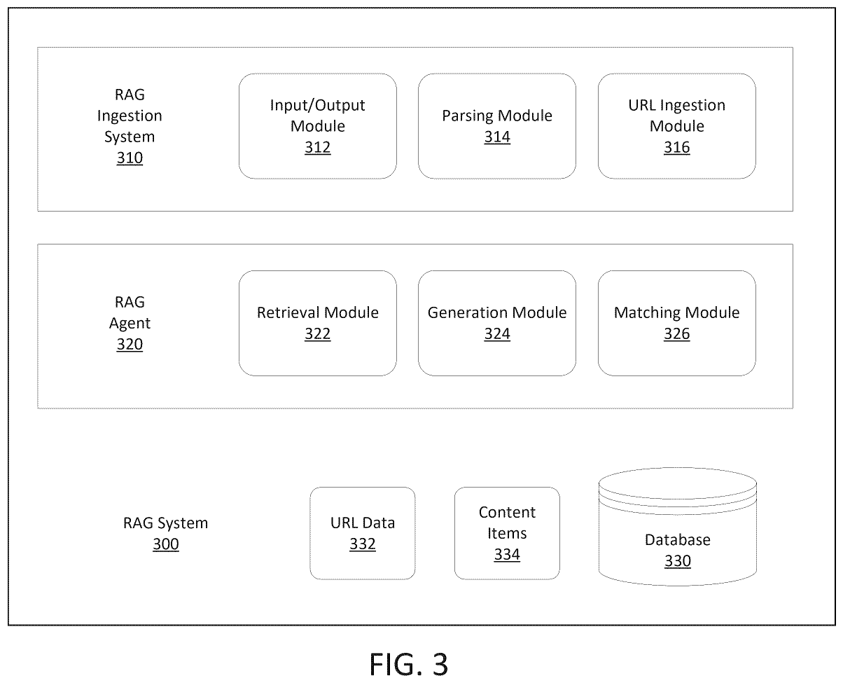

FIG. 3 illustrates a RAG system 300 in accordance with one or more embodiments. As illustrated in FIG. 3, RAG system 300 includes RAG ingestion system 310, RAG agent 320, and database 330. RAG ingestion system 310 includes input/output module 312, parsing module 314, and URL ingestion module 316. RAG agent 320 includes retrieval module 322, generation module 324, and matching module 326. Database 330 includes URL data 332 and content items 334 in an embodiment. In one or more embodiments, RAG system 300 may include more or fewer components than the components illustrated in FIG. 3. The components illustrated in FIG. 3 may be local to or remote from each other. The components illustrated in FIG. 3 may be implemented in software and/or hardware. Each component may be distributed over multiple applications and/or machines. Multiple components may be combined into one application and/or machine. Operations described with respect to one component may instead be performed by another component.

In accordance with one or more embodiments, RAG system 300 is configured as a hybrid architecture that combines retrieval-based and generative components. It integrates a dense retrieval mechanism with a generative language model, leveraging a vector database that stores encoded representations of documents. The system operates by embedding both queries and documents into a shared vector space, allowing it to effectively match queries with relevant documents based on their semantic similarity. The architecture ensures that the retrieval component can access and retrieve the most contextually relevant documents that are then used to inform the generation of responses. A generative model within RAG system 300 synthesizes information from these documents, producing coherent and context-aware outputs. The architecture is designed to support scalability, enabling the system to handle large and evolving datasets while maintaining efficient retrieval and accurate generation capabilities.

In accordance with one or more embodiments, RAG ingestion system 310 processes incoming data by first tokenizing the raw text into manageable units that may include words or subwords, depending on the tokenizer used. This step converts the text into a format suitable for further processing by the language model. Following tokenization, RAG ingestion system 310 normalizes the text by converting characters to a standard format, removing unnecessary punctuation, and handling any special characters to ensure uniformity across the dataset.

Once the text is normalized, RAG ingestion system 310 encodes it using a pre-trained language model, typically a transformer-based model. The encoding process transforms the text into dense vector representations, where each vector captures the semantic meaning of the corresponding text fragment. These vectors are stored in a vector database designed for fast retrieval operations. The database supports efficient similarity searches by organizing the vectors in a way that allows quick comparison with other vectors during query processing.

RAG ingestion system 310 also manages the integration of new documents into the existing corpus. When new data is introduced, the system automatically processes and encodes it, updating the vector database with the new vectors. This ensures that the retrieval component has access to the most current information during its operations. RAG ingestion system 310 may include mechanisms for periodic re-indexing or optimization of the vector database to maintain retrieval efficiency as the corpus grows. Additionally, RAG ingestion system 310 may handle metadata associated with each document, storing it alongside the vectors to facilitate more complex retrieval queries that take into account both the content and the context of the documents.

In accordance with one or more embodiments, input/output module 312 serves as the primary interface for data entering and exiting the system, managing the flow and integrity of data. This module may accommodate a wide range of data sources and formats to facilitate integration and communication within the system architecture.

In an embodiment, an input handler within input/output module 312 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 312 to be versatile in different operational contexts, whether processing historical datasets or streaming data.

In accordance with an embodiment, input/output module 312 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 312 includes an output framework designed to handle the distribution and exportation of outputs, predictions, or insights. Using the output framework, input/output module 312 formats these outputs into user-friendly and accessible formats, such as reports, visualizations, or data files compatible with other systems. Input/output module 312 also ensures secure and efficient transmission of these outputs to end-users or other systems in an embodiment and may employ encryption and secure data transfer protocols to maintain data confidentiality.

In accordance with one or more embodiments, parsing module 314 is configured to parse content items that contain a variety of distinct components, separating these distinct components based on their format and structure. Whether the content is embedded in documents, multimedia files, or presentation materials, parsing module 314 efficiently processes the various types of data and ensures they are categorized and separated correctly.

In accordance with one or more embodiments, in documents like PDFs, parsing module 314 identifies and separates textual data from non-textual image data by scanning the internal structure of the document. When an image is embedded, parsing module 314 recognizes the image's bounding box, isolates it as a distinct component, and simultaneously detects surrounding text through character encoding analysis. This ensures that both text and images are handled separately while maintaining their relative positions on the page for downstream processes. For vector-based images in PDFs, parsing module 314 analyzes graphic elements, such as paths and shapes, distinguishing them from raster images and text data.

In accordance with one or more embodiments, in a variety of document types, including HTML files, parsing module 314 identifies both textual elements and embedded images by examining object tags, metadata, or document markup. Text elements are processed separately from images with each component maintained independently for further processing. For example, in HTML content, some elements are recognized through tags or CSS-based properties, while text and hyperlinks are handled as separate entities.

In accordance with one or more embodiments, parsing module 314 detects hyperlinks and associated text within content items. For example, a PDF, Word, HTTML, or any other document may include a hyperlink. The hyperlink may consist of both a URL and display text. In other words, a hyperlink consists of a web address (URL) and the text that is shown to the user that can be clicked to navigate to the URL. Parsing module 314 is configured to extract the URL and associated text from the content item. In an embodiment, parsing module 314 is configured to recognize contextual data that may be associated with the hyperlink or URL.

In accordance with one or more embodiments, URL ingestion module 316 is configured to store URLs and associated information in URL data 332. URL ingestion module 316 ensures that URLs that are parsed from documents are stored in a way suitable for retrieval by RAG system 300 later. For example, URL ingestion module 316 stores URL-text pairs to ensure that URLs have associated text. The text for the URLs serve as a set of keywords that correspond to the associated URL. These keywords may be contextual text extracted from a content item such as text near a URL. For example, text may state: “The following link will take you to a presentation on machine learning.” In this case, the parsing module 312 recognizes the words “following URL” and extracts them from the document or content item. In another embodiment, the display text associated with the URL is selected as the text to be associated with the URL in URL data 332. In an embodiment, display text and contextual text may be concatenated to ensure that keywords are captured and associated with the URL.

In accordance with one or more embodiments, RAG agent 320 acts as the central coordinator within the RAG system, managing the interaction between the retrieval module 322, generation module 324, and matching module 326. It is responsible for receiving the initial query and determining the appropriate workflow to process this input. RAG agent 320 first preprocesses the query, ensuring it is formatted correctly for the retrieval module. It then directs the retrieval module to search for relevant documents that align with the query's context. Once the documents are retrieved, RAG agent 320 oversees their preparation, including any necessary reformatting or encoding, before passing them to the generation module. RAG agent 320 effectively manages the data flow, ensuring that components receive the necessary inputs at the correct stages of the process.

In accordance with an embodiment, RAG agent 320 also handles the integration of outputs from the different modules. After the generation module 324 produces a response, RAG agent 320 is tasked with processing this output, possibly performing post-processing tasks, such as formatting the response or combining it with additional information before delivering the final result. RAG agent 320 ensures that the system operates smoothly, orchestrating the components to work together, and maintaining consistency in how the query, documents, and final output are handled throughout the process.

In accordance with one or more embodiments, retrieval module 322 is configured to efficiently identify and retrieve documents that are most relevant to a given query by searching a pre-encoded vector database. Upon receiving the encoded query vector from RAG agent 320, retrieval module 322 conducts a similarity search across the database, comparing the query vector to the vectors of the documents stored in the system. The module utilizes similarity metrics, such as cosine similarity, to evaluate the degree of alignment between the query and the documents, enabling it to rank the documents according to their relevance. This ranking process helps to ensure that the most semantically similar documents are prioritized for retrieval.

Retrieval module 322 selects a subset of the top-ranked documents based on the similarity scores and prepares them for further processing. These documents are then passed back to the RAG agent for integration into the next phase of the system's operation. The retrieval module 322 is built to handle large-scale datasets, employing optimized algorithms that allow for quick retrieval times even as the size of the document corpus increases. It may also incorporate mechanisms for filtering or refining the retrieved documents, such as applying thresholds to similarity scores or considering additional metadata during the retrieval process.

In accordance with an embodiment, retrieval module 322 maintains a vector database stored in database 330 that involves updating and indexing new documents as they are ingested by the system. Retrieval module 322 ensures that the vector database remains current and accessible, supporting ongoing retrieval operations without significant delays. It also performs periodic optimizations on the database structure, such as re-indexing vectors or reorganizing data storage to maintain retrieval efficiency. By managing both the search process and the underlying data infrastructure, retrieval module 322 ensures that the RAG system 300 can consistently retrieve relevant and accurate documents in response to queries.

In accordance with one or more embodiments, generation module 324 is configured to produce a text-based response by leveraging both the query and the context provided by the retrieved documents. After receiving the necessary inputs, generation module 324 encodes these inputs into an internal representation that the model can use to generate text. The generation process operates within a transformer-based architecture that predicts each token in the output sequence based on the encoded context. The model is trained to generate coherent and contextually appropriate responses by considering both the specific content of the retrieved documents and the original query.

In accordance with one or more embodiments, generation module 324 operates iteratively, producing one token at a time, with each token being informed by both the query and the accumulated context of the previous tokens and retrieved documents. This iterative approach ensures that the response is relevant to the query and consistent with the information found in the retrieved documents. Generation module 324 is equipped to handle complex queries that require synthesizing information from multiple sources, using the context provided by the retrieved documents to guide the response generation.

In addition to generating the response, generation module 324 may apply various techniques to optimize the quality and coherence of the output. This can include using beam search to explore multiple potential sequences or applying sampling strategies to balance between generating the most probable response and maintaining diversity in the output. Once the response is fully generated, the module passes it back to the RAG agent that may perform final adjustments before delivering the response to the user. The generation module is designed to handle a wide range of query types and document contents, ensuring that the output is both informative and aligned with the context provided by the system's retrieval component.

In accordance with one or more embodiments, matching module 326 is configured to match portions of a response with keywords associated with a URL. Matching module 326 is capable of processing input queries using a variety of techniques, including natural language processing, semantic analysis, and word embeddings, to identify relevant matches within a data set. Matching module 326 can leverage context-aware models to interpret the meaning of words based on their specific context when needed, and it has the ability to apply cosine similarity to measure the relationship between vector representations of words. This allows matching module 326 to detect subtle similarities between words that may not share identical spellings but are semantically related. In cases where minor variations in spelling or incomplete matches are present, matching module 326 can employ fuzzy matching to identify words that are close in form or structure.

In accordance with one or more embodiments, attention mechanisms are another capability of matching module 326, which can be applied to prioritize the most relevant parts of the query and data set during the comparison process, improving precision in complex scenarios. When desirable, matching module 326 can directly compare query terms with words in the target data set to efficiently capture exact matches. The combination of fuzzy matching and cosine similarity is available to extend matching capabilities to near-exact terms. Matching module 326 is designed to handle a range of techniques, applying the most appropriate methods based on the generated output and the target data set.

In accordance with one or more embodiments, database 330 is any type of storage unit and/or device (e.g., a file system, database, collection of tables, or any other storage mechanism) for storing data. Furthermore, a database 330 may include multiple different storage units and/or devices. The multiple different storage units and/or devices may or may not be of the same type or located at the same physical site. Furthermore, database 330 may be implemented or executed on the same computing system as RAG system 300. Additionally, or alternatively, database 330 may be implemented or executed on a computing system separate from RAG system 300. The database 330 may be communicatively coupled to RAG system 300 via a direct connection or via a network.

In accordance with one or more embodiments, content items 334 are stored in database 330. Content items may include documents, videos, or other data files that have various types of data in addition to textual data. For example, content items may include encoded text, images of text, images having no text, tables, charts, and other information. Although raw textual data may be easily ingested for use with a RAG system, the ingestion of other types of information and storing the information in a compatible format may be more difficult to accomplish. RAG system 300 is configured to detect and ingest content items having a variety of characteristics and various types of embedded information.

Additional embodiments and/or examples relating to computer networks are described below in Section 6, titled “Computer Networks and Cloud Networks.”

Information describing RAG system 300 may be implemented across any of components within RAG system 300. However, this information is illustrated RAG system 300 for purposes of clarity and explanation.

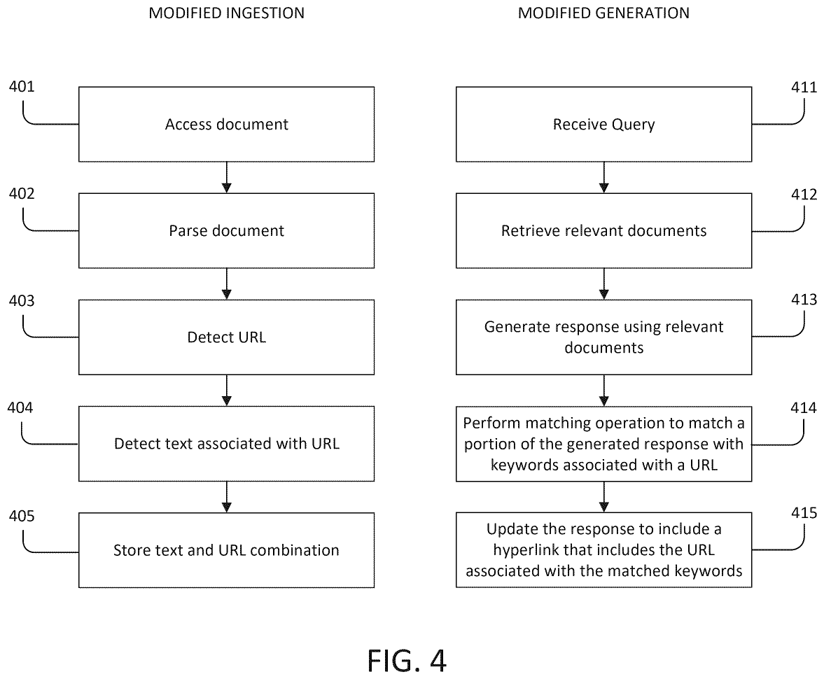

In one or more embodiments, RAG system 300 refers to hardware and/or software configured to perform operations described herein for RAG system 300. Examples of operations for RAG system 300 are described below with reference to FIG. 4.

In an embodiment, RAG system 300 is implemented on one or more digital devices. The term “digital device” generally refers to any hardware device that includes a processor. A digital device may refer to a physical device executing an application or a virtual machine.

Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface refers to hardware and/or software configured to facilitate communications between a user and RAG system 300. An interface renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, an interface is specified in one or more other languages, such as Java, C, or C++.

### 5. Url Handling in a Rag System

FIG. 4 illustrates an example set of operations for URL handling in a RAG system in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In accordance with an embodiment, the system accesses a document (Operation 401). When the system accesses a document for ingestion, it initiates a retrieval operation from the designated data source. This could involve connecting to a database, a file storage system, or an API to access the place where the document is stored. The system retrieves any raw text or structured data contained within the document, ensuring that it captures the entire content needed for subsequent processing. The access operation may involve handling various formats, such as plain text, PDFs, or HTML, and converting these into a standardized format that the ingestion pipeline can process. This step ensures that the document is ready to be parsed and encoded into the system's internal representations.

In accordance with an embodiment, the system parses the document (Operation 402). The system parses the document to analyze its content. The parsing process involves breaking down the document into its constituent elements, such as sentences, paragraphs, or sections, depending on the document's structure. The system identifies key features within the text, such as headings, keywords, and entities, using natural language processing techniques to extract relevant information. This analysis allows the system to understand the document's structure, content, and context that is helpful for encoding it into vector representations that capture the semantic meaning. The parsed data is then prepared for encoding and indexing in the vector database, making it accessible for retrieval during the query process.

In accordance with an embodiment, the system detects a URL in the document (Operation 403). As the system parses the document, it specifically searches for URLs. URLs follow a general pattern that includes a protocol (like http://, https://, ftp://, etc.), followed by the domain name, and possibly a path, query parameters, and fragments. The system can use regular expressions (regex) to identify these patterns in the text.

In accordance with an embodiment, to find URLs in a non-text-based PDF document, the system first converts the PDF pages into images if the document consists of scanned pages or images instead of text. This conversion typically involves using libraries, such as PyMuPDF or pdf2image, which render each page of the PDF as an image. Once the pages are in image format, the program applies Optical Character Recognition (OCR) to extract text from these images. The OCR process relies on algorithms that analyze the shapes and patterns of characters in the image, identifying text that can then be processed as a string. Images can be processed in the same way, resulting in text that can be processed using regular expressions or other technology. Other files may include URLs. For video or audio content items, for example, URLs may be detected using libraries designed to extract textual data from video and audio.

In accordance with an embodiment, the system detects text associated with URL in the document (Operation 404). Detecting text associated with a URL in a document involves analyzing the document's content to identify both contextual text around the URL and the display text in a hyperlink.

In accordance with an embodiment, for contextual text, the system first identifies the URL within the document, typically using a regular expression that matches URL patterns. Once the URL is located, the system examines the text immediately preceding and following the URL within a specified range. The system defines this range to capture relevant contextual information without including too much unrelated content. The process involves extracting a substring of text around the URL, often by determining an appropriate number of characters or words on either side of the URL. The extracted text is then analyzed to identify the context in which the URL is embedded. This context might include sentences, phrases, or keywords that provide information about the purpose or content of the URL. The system might use natural language processing (NLP) techniques to further analyze and classify the contextual text, identifying themes or topics related to the URL.

In accordance with an embodiment, for detecting display text in a hyperlink, the system takes a different approach. Hyperlinks in documents, especially in HTML or PDF formats, are typically embedded in specific tags or structures. In an HTML document, the system locates anchor (<a>) tags that contain both the URL (in the href attribute) and the display text that is the text between the opening and closing <a> tags. The system parses the document's HTML structure, extracts the href attribute value (the URL), and simultaneously retrieves the text enclosed by the anchor tags. This text is the display text associated with the URL. The system then pairs the extracted URL with its corresponding display text, allowing for an understanding of how the URL is presented to the user.

In accordance with an embodiment, hyperlinks in PDFs may be represented differently. The system first recognizes the hyperlink annotations embedded in the PDF, which may involve parsing the PDF's structure at a low level, often using a library that can interpret PDF objects as discussed above. These annotations contain the URL and may also include a reference to the text displayed on the page. The system maps the hyperlink annotation to the text displayed at the same location on the page, thereby identifying the display text associated with the URL.

In accordance with an embodiment, the system stores the text and URL combination (Operation 405). If both contextual and display text are found, the system may concatenate both sets of text together before storing the text and the URL. However, the system may select one without the other based on the circumstances. For example, the system may be configured to select only display text by default, but if no display text is available, the system will select contextual text. Once the system determines which text should be stored with the URL, the system stores the URL and the selected text together in a database or other storage system.

Once the text and the URL are stored, they may be used in a modified RAG generation operation. In accordance with an embodiment, more than one URL may be found in a single document, and each URL may be stored in connection with text corresponding to that URL. In addition, there is no limit to the number of URL-text combinations that may be stored and then later used to respond to a query.

In accordance with an embodiment, URLs may be accessed to create additional keywords to associate with the URL that may be more accurate than the contextual text or the display text associated with the URL. If an error is detected, the system may remove the URL from the URL-text mapping.

In an embodiment, the system follows a URL and generates keyword information by first sending an HTTP request to the specified URL, retrieving the page's content. This content, typically composed of HTML, CSS, JavaScript, and other resources, is parsed to isolate the textual elements from the non-textual ones. The system ignores elements like scripts and stylesheets, focusing on extracting the raw text contained within HTML tags. Once the text is isolated, it undergoes preprocessing steps including tokenization, where the text is split into individual words or phrases, and stop word removal, which eliminates common words that do not contribute significant meaning. This raw text data serves as the foundation for further keyword extraction processes.

The system employs various natural language processing techniques to identify and rank keywords within the extracted text. One method, term frequency analysis, involves counting the occurrence of each word or phrase to determine its prominence within the document. Another method is term frequency-inverse document frequency (TF-IDF), which calculates the significance of a word in the context of a larger corpus of documents, thereby distinguishing more meaningful keywords from less relevant ones. Named entity recognition (NER) may be used to detect specific entities, such as names of people, organizations, or locations, that can be useful for understanding the context of the content. Additionally, advanced techniques, like word embeddings or topic modeling, might be utilized to capture the semantic relationships between words, enabling the system to group related terms or identify overarching themes in the text.

In an embodiment, the identified keywords are then compiled into a structured format that may be organized by their relevance or frequency. This list of keywords can be directly extracted or further refined based on specific criteria or thresholds. The final output may include single words, multi-word phrases, or named entities, depending on the system's configuration and the content of the webpage. These keywords are then made available for various downstream applications, such as enhancing search engine optimization efforts, informing content categorization, or feeding into recommendation systems. The entire process is automated, allowing the system to process multiple URLs and generate keyword information efficiently and at scale.

In accordance with an embodiment, the retrieval and processing may take place as URL-text combinations are initially entered into the database. Alternatively, the initial URL-text mapping may be stored, followed by subsequent retrieval from the URL itself at a time that is more convenient or when more system resources are available. The additional keywords derived from the accessed URLs are used to augment the URL-text mapping already stored. This added information is valuable because it is derived from URLs found in documents, meaning that the information found at each URL is not already included in the content items that are used in the document retrieval portion of the RAG process.

In accordance with an embodiment, the system receives a query (Operation 411). The query acts as the initial input triggering the operations within the Retrieval-Augmented Generation (RAG) framework. This query, provided by the user, can take various forms, such as a question, a request for information, or a prompt requiring specific output. The query serves as the basis for the system's subsequent actions, defining the scope and focus of the task at hand. It is the point of interaction between the user and the system, initiating the process that will eventually lead to generating a response that directly addresses the user's needs.

In accordance with an embodiment, the system retrieves one or more relevant documents that may be used to generate a response to the query (Operation 412). The system begins with the representation of the user's query in a format that enables efficient comparison against a large set of documents or text passages. This involves transforming the query into a vector representation, typically using an embedding model that maps the text into a high-dimensional vector space. The embedding model is trained to capture semantic similarities between different pieces of text, meaning that similar queries will result in vectors that are close together in this space.

In accordance with an embodiment, once the query is embedded, the system compares it against the precomputed vectors of documents or passages within the knowledge base. This comparison often utilizes a similarity metric, such as cosine similarity, which measures the cosine of the angle between the query vector and document vectors. A smaller angle corresponds to a higher similarity, indicating that the content of the document is more relevant to the query. The system identifies the documents with the highest similarity scores and considers them as candidates for retrieval.

In accordance with an embodiment, in cases where the system employs a two-stage retrieval approach, the process begins with a sparse retrieval phase, where documents are initially filtered based on the presence of specific keywords derived from the query. This phase uses inverted indices, where documents are indexed by keywords, allowing for rapid identification of relevant documents based on keyword overlap with the query. Documents passing this initial filtering are then subjected to dense retrieval, where a neural network-based model evaluates the semantic similarity between the query and documents at a deeper level. This dense retrieval model may involve fine-tuned transformers or other deep learning architectures that understand context and meaning beyond mere keyword matching.

The final set of documents selected through this retrieval process is ranked by relevance scores that reflect how closely documents align with the query in both a sparse and dense sense. The top-ranked documents are then passed on to the generation phase, where they serve as the knowledge base from which the system constructs a response. This ensures that the response generation is informed by the most relevant and contextually appropriate information extracted from the corpus, enabling the system to provide accurate and context-aware outputs.

In accordance with an embodiment, the system generates a response to the query using the relevant documents (Operation 413). The system integrates the retrieved information into the language model's context. The retrieved documents that provide the factual basis for the response are combined with the original query and fed into the language generation model. This model, which may be a large pre-trained transformer, processes the combined input to generate coherent and contextually appropriate text.

In accordance with an embodiment, the model tokenizes the input, breaking down the query and the retrieved documents into smaller units, such as words or subwords. These tokens are then passed through multiple layers of the transformer model, where each layer applies a series of mathematical operations to refine the representation of the text. The attention mechanism within the transformer helps the model identify the parts of the input that are most relevant to the query, allowing it to prioritize certain information from the retrieved documents when generating the response.

In accordance with an embodiment, as the model processes each token, it predicts the next token in the sequence, gradually constructing the response word by word. This process continues until the model produces a complete response that addresses the query. Throughout this process, the model draws heavily on the context provided by the retrieved documents, ensuring that the response is informed by the most relevant information available. The generated text is then output as the final response, ready for presentation to the user. This process is designed to ensure that the generated response is both coherent and contextually aligned with the input query and the supporting documents.

In accordance with an embodiment at this stage, a response to the query has been generated. The response may be sent to a user interface before moving on to the next step in an embodiment, allowing the user to decide whether or not to augment the response with URL information. For example, the user may select a user interface element indicating that an URL-augmented response is desired. Alternatively, users, or other consumers of the generated output, may receive URL-augmented responses by default.

Less sophisticated RAG systems often hallucinate URLs due to their inherent reliance on pattern recognition rather than real-time web access. During training, LLMs ingest vast amounts of text, including web addresses, and learn patterns in the structure of URLs. When prompted, they attempt to generate plausible URLs based on these patterns but lack the ability to verify their existence or accuracy. In the case of URLs, the hallucination issue stems from a model's inability to distinguish between factual and generative content in contexts where the underlying dataset lacks precise or up-to-date information. Hallucinated URLs present significant problems, including misdirecting users, potentially leading to security risks, or generating confusion when the links do not work.

In accordance with an embodiment, the system manages URL generation differently to avoid hallucination. The system performs a matching operation to match a portion of the generated response with keywords associated with a URL (Operation 414). The system is first tasked with selecting different portions of text from a document or a paragraph in the document and finding relevant information corresponding to the portions. In an embodiment, the process involves several steps that are driven by natural language processing (NLP) techniques. The system first segments the text into meaningful units, then analyzes the content of each segment to determine its context and meaning, and finally matches these segments with relevant keyword information. This process involves several components.

In accordance with an embodiment, the system begins by segmenting the paragraph into smaller units of text, such as sentences, phrases, or even individual clauses. This segmentation is typically performed using syntactic parsing, where the system identifies the grammatical structure of the sentence, breaking it down into its constituent parts. Parsing techniques, such as dependency parsing or constituency parsing, are commonly used to understand the relationships between words and identify the boundaries of these segments. For example, a dependency parser would identify the subject, verb, and object in a sentence, enabling the system to focus on each segment independently.

In accordance with an embodiment, once the text is segmented, the system performs semantic analysis on each portion to understand its meaning and context. This involves using word embeddings or context-aware models, like BERT, to generate vector representations of each segment. These vectors capture the semantic meaning of the text, allowing the system to compare the segments with other pieces of information in a relevant knowledge base or external dataset. The system evaluates the semantic similarity between the vectors representing the text segments and those of potential matches, often using measures, like cosine similarity, to quantify how closely the meanings align. This step ensures that the system can identify relevant information even when the exact wording differs between the text segment and the external information.

In accordance with an embodiment, the system decides which portions of text to match with keyword information in the URL-text mapping. This decision is typically based on the context and importance of the segments as determined by the semantic analysis. The system might prioritize certain segments based on their semantic weight or relevance within the paragraph. For instance, key phrases that represent central ideas or concepts in the paragraph may be given more importance during the matching process. Additionally, the system may use attention mechanisms, particularly in transformer-based models, to focus on the most relevant parts of the text, ensuring that the matching process targets the portions of the paragraph that are most likely to yield valuable information when matched with external sources.

Through this combination of syntactic parsing, semantic analysis, and context-driven prioritization, the system effectively decides which portions of text to match with other relevant information, ensuring that the connections made are meaningful and contextually appropriate.

In accordance with an embodiment, the system performs a matching operation by directly comparing the query terms with the words present in the URL-text mapping. An embodiment relies on string matching, where the system searches for occurrences of the exact sequence of characters as provided in the query. Algorithms like the Knuth-Morris-Pratt (KMP) or Boyer-Moore algorithm may be used for this task, optimizing the search process by efficiently skipping unnecessary character comparisons, thereby allowing faster identification of keyword positions within the text. This method matches query terms based on their textual form without regard for context or meaning.

In accordance with an embodiment, in addition to basic matching, the system may incorporate techniques, like stemming and lemmatization, to enhance matching capabilities.

Stemming reduces words to their root forms, often by stripping affixes, while lemmatization considers the word's morphological form and context to return the correct base or dictionary form. For example, the terms “running,” “ran,” and “runner” might be processed to match the base form “run.” This may be done using algorithms, such as the Porter Stemmer, or libraries, like WordNet, for lemmatization, which enable the system to identify and match various inflections of a word, broadening the scope of content retrieval.

In accordance with an embodiment, the system may also utilize fuzzy matching to handle minor variations and misspellings in query terms. Fuzzy matching algorithms, such as the Levenshtein distance algorithm, calculate the number of edits needed to transform one string into another, allowing the system to match terms that are similar but not identical. This approach is useful for capturing typographical errors or slight variations in terminology. Despite the enhancements provided by stemming, lemmatization, and fuzzy matching, keyword matching remains focused on the explicit text present within the content, without interpreting the deeper semantic relationships between words.

In accordance with an embodiment, the system functions by interpreting the meaning and context of the words in both the query and the content. This approach often involves using NLP techniques, with word embeddings being a common method. Word embeddings represent words or phrases as vectors in a multi-dimensional space, where semantically similar words are placed closer together. These embeddings are generated by models, like Word2Vec or GloVe, which analyze large text corpora to learn relationships between words based on their co-occurrence patterns. The system can then compare the vector representations of query terms with those in the target documents to identify semantically similar matches even in the absence of exact keyword matches.

In an embodiment, the system may employ pre-trained word embeddings or develop domain-specific embeddings through training on relevant datasets. When a query is processed, the module generates vector representations for the query terms and compares them to the vector representations of the content. This comparison typically involves calculating cosine similarity, a measure that quantifies the angle between two vectors in the embedding space. Higher cosine similarity indicates that the vectors are closely aligned, suggesting that the words or phrases are semantically related. This method allows the module to retrieve content that aligns with the intended meaning of the query, extending beyond the limitations of exact keyword matching.

In accordance with an embodiment, the system may also leverage more advanced models, like Bidirectional Encoder Representations from Transformers (BERT), which generate context-aware embeddings by considering the surrounding words in a sentence. BERT processes text in both directions, analyzing the context of a word based on the words that appear before and after it. This bidirectional approach enables the system to capture the nuanced meanings of words in various contexts. For example, the word “bank” would generate different embeddings depending on whether it appears in a financial context or a geographical context, such as the bank of a river. By using these contextually informed embeddings, the system can retrieve URLs that include information that is more accurately aligned with the user's intent.

In an embodiment, the system continues to match URLs that may be relevant to the query. Given the context, length, or content of a query, any number of URLs may be determined to be relevant. For example, a query that includes more than one question may result in the selection of one or more URLs for each question in the query. A different query may explicitly request a set number or minimum number of URLs to be presented. Additionally, a query that includes only one explicit question may include enough context to match a larger set of URLs.

In accordance with one or more embodiments, the system employs semantic matching techniques. Semantic matching refers to the process of evaluating and identifying the similarity or relatedness of two or more pieces of information based on their meaning, rather than just their surface-level characteristics like keywords or syntax. In systems that use semantic matching techniques, the focus is on understanding the context, relationships, and concepts behind the data to make more intelligent comparisons or connections. For example, the system can recognize that “car” and “automobile” are similar even though the words are different. This technique allows the system to find relevant information, even if exact words or phrases don't match, by focusing on the underlying meaning.

In accordance with one or more embodiments, the system employs adaptive matching approaches, allowing for flexible and comprehensive hypertext identification by using a variety of matching techniques. The system uses hybrid matching when keyword search fails, optimizing both speed and accuracy. Specifically, adaptive matching refers to the general strategy we used to match URL links to the generated response from the RAG agent. The system adaptively chooses a matching method to ensure that the URLs can be accurately matched to the response with low latency. For example, the system may perform keyword matching which prioritizes the matching speed. If this step fails, the system may select a semantic matching approach to increase the matching accuracy by evaluating the semantic similarity between the keywords associated with the URL and the response text. The system adapts the matching approach based on the performance of the matching given the context of the generated response.

In accordance with an embodiment, the matching function may return a set of URLs that includes one or more duplicates. For example, a query may include a set of questions or requests, with an expected answer for each. In an embodiment, the system performs a deduplication procedure to ensure that no two URLs presented in the response are the same. In an embodiment, URLs are normalized. For example, extra spaces may be removed if present, text may be converted to lowercase, and other transformations that help identify duplicates more easily may be applied.

In an embodiment, the system performs normalization techniques that may assist with errors encountered in the OCR process. For example, the system standardizes the protocol to ensure consistent representation. It converts all protocol values to lowercase, preferring one protocol over another when necessary, or removing the protocol entirely if deemed equivalent. In some cases, the “www” subdomain is stripped, as it often points to the same resource. The domain portion of the URL is also converted to lowercase since URL domains are case-insensitive. This ensures that variations in capitalization do not lead to duplicate entries. The system may also simplify the path portion of a URL. For example, the system resolves redundant characters such as double slashes and corrects directory traversal elements like “./” or “../” to ensure the path is in its most direct form. It also removes default filenames such as “index.html” or “default.asp” when these files represent the same directory or resource. The system ensures that path normalization accounts for both case-sensitive and case-insensitive scenarios based on server configurations. In an embodiment, the system also removes or reorders query parameters based on predefined rules. Tracking parameters, including those commonly associated with ad campaigns, session management, or other extraneous information, are stripped from the URL. Other portions of a URL that may be discarded or disregarded include portions that are not relevant to the use of a URL as a resource locator, such as anything after a question mark. In an embodiment, port numbers and fragments are also discarded or disregarded.

In an embodiment, normalization of URLs may also be performed during the ingestion process. For example, if two documents include the same URL, the system may compare the URLs after normalization and discard one of the records. When this happens, the system will ensure that additional keywords associated with the URL are added to the record that remains.

In accordance with an embodiment, the system updates the generated response to include a hyperlink that uses the URL associated with the matched keywords (Operation 415). When the system finds a match for a portion of text, the system replaces that text with a hyperlink that uses the portion of text as the display text and the matched URL as the underlying URL.

In an embodiment, the system places a URL in the response based on its context and purpose. For example, the system may determine that a URL is to be used as a reference at the end of a response because the URL serves a supporting or citation role rather than being part of the main content. This context may be stored in connection with the URL as metadata, based on the context of the URL in the original ingested document. For example, if the URL was found as a citation in the original ingested document, then the system may present the URL in the same context when it is part of a response to a query. In this case, the system appends the URL to a designated section portion of the response.

In an embodiment, the system embeds a URL inline with the text when the system determines that the URL is directly relevant to the content being presented in the response. In these cases, the system may place the URL in the portion of the response where the content requires immediate reference or action. For example, when displaying a hyperlink within the response, the system inserts the URL either as the visible text or behind anchor text that reflects relevant keywords or descriptive text. The anchor text may instead be relevant text from the generated response, resulting in the use of display text that may not include keywords or the URL itself. The decision to use anchor text instead of displaying the full URL is based on readability and context in an embodiment. Alternatively, the system may be configured to always use one method over another. If using anchor text, the system processes the content to match the keywords, descriptive phrases, or generated text relevant to the URL and generates the anchor link.

In an embodiment, the system determines placement of a URL based on factors such as whether the URL provides background information or supports an argument. If the URL is more appropriate as a background resource, the system places it in a separate references section. If the URL is essential to the immediate content, it is inserted inline. In both scenarios, the system ensures proper formatting and linkage between the URL and the surrounding text, regardless of where the URL appears in the response.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

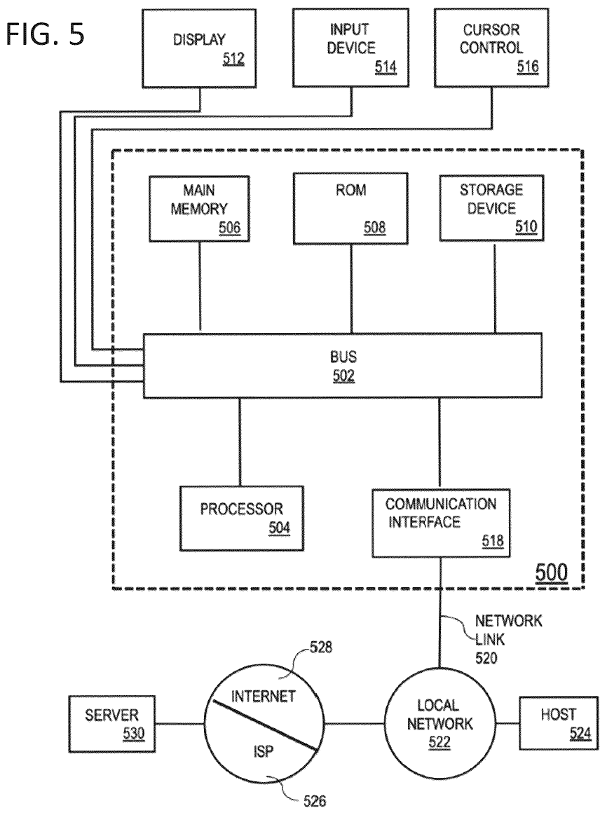

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving a query;
using a generative model, generating a response to the query;
subsequent to generating the response, performing a matching operation to match a portion of the response to one or more URLs in a URL dictionary;
in response to determining that a first portion of the response matches a first URL in the URL dictionary, updating the response to create an updated response, wherein
updating the response comprises:
generating a first content element using the first URL;
adding the first content element to the response to create the updated response; and
responding to the query with the updated response.

2. The non-transitory media of claim 1, wherein the operations further comprise:
subsequent to generating the response, and before performing the matching operation, responding to the query with the response.

3. The non-transitory media of claim 2, wherein the response is sent to a user interface for the purpose of displaying the response, and wherein responding to the query with the updated response comprises sending instructions to the user interface to replace the response displayed in the user interface with the updated response.

4. The non-transitory media of claim 3, wherein the matching operation is performed in response to a request from the source of the query.

5. The non-transitory media of claim 1, wherein the matching operation comprises:
performing a keyword matching operation to explicitly match the first portion of the response with one or more keywords corresponding to the URL in the URL dictionary.

6. The non-transitory media of claim 1, wherein the matching operation comprises:
performing a semantic matching operation to implicitly match the first portion of the response with one or more keywords corresponding to the URL in the URL dictionary.

7. The non-transitory media of claim 1, wherein the first content element comprises a first hyperlink.

8. The non-transitory media of claim 7, wherein the operations further comprise:
in response to determining that a second portion of the response matches a second URL in the URL dictionary:
generating a second content element using the second URL; and
adding the second content element to the updated response.

9. The non-transitory media of claim 8, wherein the second content element comprises a second hyperlink.

10. The non-transitory media of claim 7, wherein first hyperlink comprises the first URL and a second portion of the response to the query, wherein the display text portion of the first hyperlink comprises the second portion of the response to the query.

11. The non-transitory media of claim 7, wherein first hyperlink comprises the first URL, wherein the display text portion of the first hyperlink comprises the first URL.

12. The non-transitory media of claim 7, wherein first hyperlink comprises the first URL, wherein the display text portion of the first hyperlink comprises a keyword associated with the first URL in the URL dictionary.

13. The non-transitory media of claim 7, wherein the matching operation is an adaptive matching operation that comprises:
executing a first matching operation; and
in response to determining that the first matching operation resulted in unsatisfactory matching results, executing a second matching algorithm that is different from the first matching operation.

14. The non-transitory media of claim 7, wherein the URL dictionary comprises a mapping between one or more URLs and a set of keywords associated with each URL of the one or more URLs.

15. The non-transitory media of claim 14, wherein the operations further comprise:
prior to receiving the query, ingesting a first document, wherein the step of ingesting the first document comprises:
detecting first text in the first document;
detecting the first URL in the first document;
determining that a first portion of the first text corresponds to the first URL; and
storing a first keyword associated with the first portion of the first text in the URL dictionary and mapping the first keyword to the first URL in the URL dictionary.

16. The non-transitory media of claim 15, wherein the step of ingesting the first document further comprises:
accessing a second document located at the URL;
detecting second text in the second document; and
storing a second keyword associated with the second document in the URL dictionary and mapping the second keyword to the first URL in the URL dictionary.

17. The non-transitory media of claim 16, wherein the operations further comprise:
prior to receiving the query, using the second text to train the generative model; and
wherein a portion of the second text influences the generative model in generating the response.

18. The non-transitory media of claim 7, wherein creating the updated response comprises:
determining a context associated with the URL in the first document;
based at least in part on the context, determining a first position in the updated response in which to place the hyperlink; and
placing the hyperlink in the first position in the updated response.

19. A system, comprising:
at least one device including a hardware processor;
the system being configured to perform operations comprising:
receiving a query;
using a generative model, generating a response to the query;
subsequent to generating the response, performing a matching operation to match a portion of the response to one or more URLs in a URL dictionary;
in response to determining that a first portion of the response matches a first URL in the URL dictionary, updating the response to create an updated
response, wherein updating the response comprises:
generating a first content element using the first URL;
adding the first content element to the response to create the updated response; and
responding to the query with the updated response.

20. A method, comprising:
receiving a query;
using a generative model, generating a response to the query;
subsequent to generating the response, performing a matching operation to match a portion of the response to one or more URLs in a URL dictionary;
in response to determining that a first portion of the response matches a first URL in the URL dictionary, updating the response to create an updated response, wherein
updating the response comprises:
generating a first content element using the first URL;
adding the first content element to the response to create the updated response;
responding to the query with the updated response; and
wherein the method is performed by at least one device including a hardware processor.
